(19) United States
(12) Patent Application Publication
(10) Pub. No.: US 2008/0081874 A1
(43) Pub. Date: Apr. 3, 2008

(54) POLY(ARYLENE ETHER) COMPOSITION, METHOD, AND ARTICLE

(76) Inventors: Kim Balfour, Delanson, NY (US); Hua Guo, Selkirk, NY (US); Vijay Mhetar, Slingerlands, NY (US)

Correspondence Address: CANTOR COLBURN LLP - SABIC (NORYL), 20 Church Street, 22nd Floor, Hartford, CT, 06103, US

(21) Appl. No.: 11/536,749

(22) Filed: Sep. 29, 2006

(51) Int. Cl. C08L 53/00

(52) U.S. Cl. 525/98

(57) ABSTRACT

A composition includes a poly(arylene ether) and a crosslinked block copolymer of an alkenyl aromatic monomer, such as styrene, and a conjugated diene, such as butadiene. The crosslinked block copolymer includes 50 to about 90 weight percent of repeating units derived from the alkenyl aromatic monomer. The composition exhibits improved ductility relative to a corresponding composition in which the block copolymer is not crosslinked.

### BACKGROUND OF THE INVENTION

Poly(arylene ether) resin is a type of plastic known for its excellent water resistance, dimensional stability, and inherent flame retardancy. Properties such as strength, stiffness, chemical resistance, and heat resistance can be tailored by blending it with various other plastics in order to meet the requirements of a wide variety of consumer products, for example, plumbing fixtures, electrical boxes, automotive parts, and coated wire. Common plastics blended with poly(arylene ether) include polystyrenes, nylons, and polyolefins. Unfortunately, these blended materials are typically opaque making them unsuitable for certain products, such as heat-resistant packaging that requires translucency or transparency

One particular type of styrenic resin that poly(arylene ether)s have been blended with is styrenic block copolymers. These styrenic block copolymers include at least one “hard” chain and at least one “rubbery chain”. Compositions containing poly(arylene ether)s and styrenic block copolymers are valued for their improved properties relative to either resin type alone. For example, U.S. Pat. No. 3,660,531 to Lauchlan describes blends of polyphenylene ethers with styrene-butadiene block copolymers and teaches that the blends exhibit improved melt processability and impact resistance without sacrificing the desirable heat distortion temperature and flexural modulus of unmodified polyphenylene ether. As another example, U.S. Pat. No. 5,234,994 to Shiraki et al. describes blends of a polyphenylene ether, a block copolymer of a vinyl aromatic hydrocarbon and a conjugated diene, and polystyrene. The blends are described as offering improved transparency, impact resistance, surface hardness, heat resistance, and gloss. As yet another example, U.S. Pat. No. 6,274,670 to Adedeji et al. describes a composition comprising a polyphenylene ether resin, a non-elastomeric styrenic resin, and an unsaturated elastomeric styrenic block copolymer. When the non-elastomeric styrenic resin is a styrene-butadiene block copolymer having at least 50 weight percent styrene, these compositions are semi-transparent and exhibit enhanced processability.

Even though considerable progress that has been made in creating new blends of poly(arylene ether)s and styrenic block copolymers, there is still a need in the packaging industry, among others, for compositions that exhibit improved impact strength without sacrificing transparency.

### BRIEF DESCRIPTION OF THE INVENTION

The above-described and other drawbacks are alleviated by various embodiments described herein. One embodiment is a composition, comprising: a poly(arylene ether); and a crosslinked block copolymer of an alkenyl aromatic monomer and a conjugated diene; wherein the crosslinked block copolymer comprises 50 to about 90 weight percent of repeating units derived from the alkenyl aromatic monomer.

One embodiment is a composition, consisting of: a poly(arylene ether); a crosslinked block copolymer of an alkenyl aromatic monomer and a conjugated diene; wherein the crosslinked block copolymer comprises 50 to about 90 weight percent of repeating units derived from the alkenyl aromatic monomer; optionally, a homopolystyrene; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

One embodiment is a composition, comprising: a poly(arylene ether) comprising 2,6-dimethyl-1,4-phenylene ether units and having an intrinsic viscosity of about 0.3 to about 0.6 deciliter per gram, measured at 25° C. in chloroform; and a crosslinked block copolymer of an alkenyl aromatic monomer and a conjugated diene; wherein the crosslinked block copolymer comprises about 60 to about 85 weight percent of repeating units derived from the alkenyl aromatic monomer; wherein the alkenyl aromatic monomer is styrene; wherein the conjugated diene is 1,3-butadiene, 2-methyl-1,3-butadiene, or a combination thereof; wherein the crosslinked block copolymer comprises a reaction product of an uncrosslinked block copolymer and a peroxide compound; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767.

Another embodiment is a composition, consisting of: a poly(arylene ether) comprising 2,6-dimethyl-1,4-phenylene ether units and having an intrinsic viscosity of about 0.3 to about 0.6 deciliter per gram, measured at 25° C. in chloroform; and a crosslinked block copolymer of an alkenyl aromatic monomer and a conjugated diene; wherein the crosslinked block copolymer comprises about 60 to about 85 weight percent of repeating units derived from the alkenyl aromatic monomer; wherein the alkenyl aromatic monomer is styrene; wherein the conjugated diene is 1,3-butadiene, 2-methyl-1,3-butadiene, or a combination thereof; wherein the crosslinked block copolymer comprises a reaction product of an uncrosslinked block copolymer and a peroxide compound; optionally, a homopolystyrene; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof, wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767.

Another embodiment is a composition, comprising: about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer; wherein the alkenyl aromatic monomer is styrene; wherein the conjugated diene is 1,3-butadiene; wherein the crosslinked tapered block copolymer comprises a reaction product of an uncrosslinked tapered teleblock copolymer and dicumyl peroxide; wherein all parts by weight are based on 100 parts by weight total of the poly(arylene ether) and the crosslinked tapered block copolymer; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

Another embodiment is a composition, consisting of: about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer; wherein the alkenyl aromatic monomer is styrene; wherein the conjugated diene is 1,3-butadiene; wherein the crosslinked tapered block copolymer comprises a reaction product of an uncrosslinked tapered teleblock copolymer and dicumyl peroxide; optionally, about 0.1 to about 100 parts by weight of a homopolystyrene per 100 parts by weight total of the poly(arylene ether) and the crosslinked block copolymer; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof, wherein all parts by weight are based on 100 parts by weight total of the poly(arylene ether) and the crosslinked tapered block copolymer; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

Another embodiment is a method of forming a thermoplastic composition, comprising: melt kneading a poly(arylene ether) and a crosslinked block copolymer of an alkenyl aromatic monomer and a conjugated diene; wherein the crosslinked block copolymer comprises 50 to about 90 weight percent of repeating units derived from the alkenyl aromatic monomer.

Another embodiment is a method of forming a thermoplastic composition, comprising: melt kneading a crosslinking agent and an uncrosslinked block copolymer of an alkenyl aromatic monomer and a conjugated diene to form a crosslinked block copolymer; wherein the uncrosslinked block copolymer comprises 50 to about 90 weight percent of repeating units derived from the alkenyl aromatic monomer; and melt kneading a poly(arylene ether) with the crosslinked block copolymer.

Another embodiment is an article comprising a composition, comprising: a poly(arylene ether); and a crosslinked block copolymer of an alkenyl aromatic monomer and a conjugated diene; wherein the crosslinked block copolymer comprises 50 to about 90 weight percent of repeating units derived from the alkenyl aromatic monomer.

Another embodiment is an article comprising a composition, consisting of: a poly(arylene ether); a crosslinked block copolymer of an alkenyl aromatic monomer and a conjugated diene; wherein the crosslinked block copolymer comprises 50 to about 90 weight percent of repeating units derived from the alkenyl aromatic monomer; optionally, a homopolystyrene; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

Another embodiment is an article comprising a composition, comprising: a poly(arylene ether) comprising 2,6-dimethyl-1,4-phenylene ether units and having an intrinsic viscosity of about 0.3 to about 0.6 deciliter per gram, measured at 25° C. in chloroform; and a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer; wherein the alkenyl aromatic monomer is styrene; wherein the conjugated diene is 1,3-butadiene, 2-methyl-1,3-butadiene, or a combination thereof; wherein the crosslinked tapered block copolymer comprises a reaction product of an uncrosslinked tapered block copolymer and a peroxide compound; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767.

Another embodiment is an article comprising a composition, consisting of: a poly(arylene ether) comprising 2,6-dimethyl-1,4-phenylene ether units and having an intrinsic viscosity of about 0.3 to about 0.6 deciliter per gram, measured at 25° C. in chloroform; and a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer; wherein the alkenyl aromatic monomer is styrene; wherein the conjugated diene is 1,3-butadiene, 2-methyl-1,3-butadiene, or a combination thereof; wherein the crosslinked tapered block copolymer comprises a reaction product of an uncrosslinked tapered block copolymer and a peroxide compound; optionally, a homopolystyrene; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767.

Another embodiment is an article comprising a composition, comprising: about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer; wherein the alkenyl aromatic monomer is styrene; wherein the conjugated diene is 1,3-butadiene; wherein the crosslinked tapered block copolymer comprises the reaction product of an uncrosslinked tapered teleblock copolymer and dicumyl peroxide; wherein all parts by weight are based on 100 parts by weight total of the poly(arylene ether) and the crosslinked tapered block copolymer; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

Another embodiment is an article comprising a composition, consisting of: about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer; wherein the alkenyl aromatic monomer is styrene; wherein the conjugated diene is 1,3-butadiene; wherein the crosslinked tapered block copolymer comprises the reaction product of an uncrosslinked tapered teleblock copolymer and dicumyl peroxide; optionally, about 0.1 to about 100 parts by weight of a homopolystyrene per 100 parts by weight total of the poly(arylene ether) and the crosslinked block copolymer; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof; wherein all parts by weight are based on 100 parts by weight total of the poly(arylene ether) and the crosslinked tapered block copolymer; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

Another embodiment is a crosslinked block copolymer concentrate, comprising: at least 80 weight percent of a crosslinked block copolymer of an alkenyl aromatic monomer and a conjugated diene; wherein the crosslinked block copolymer comprises 50 to about 90 weight percent of repeating units derived from the alkenyl aromatic monomer.

Another embodiment is a crosslinked block copolymer concentrate, consisting of: at least 80 weight percent of a crosslinked block copolymer of an alkenyl aromatic monomer and a conjugated diene; wherein the crosslinked block copolymer comprises 50 to about 90 weight percent of repeating units derived from the alkenyl aromatic monomer; optionally, about 1 to about 20 weight percent of a homopolystyrene; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; and optionally, the residue of a crosslinking agent selected from the group consisting of sulfur, sulfur donor compounds, peroxide compounds, hydroperoxide compounds, azo compounds, electromagnetic radiation capable of generating free radicals, electron beams, and combinations thereof.

Another embodiment is a crosslinked block copolymer concentrate, comprising: about 87 to about 97 weight percent of a crosslinked block copolymer of styrene and butadiene; wherein the crosslinked block copolymer comprises 60 to about 85 weight percent of repeating units derived from styrene and about 15 to about 40 weight percent of repeating units derived from butadiene; and about 3 to about 13 weight percent of a homopolystyrene; wherein the composition exhibits an extent of crosslinking characterized by an average T₁/T₂ value of 557 to 728.

Another embodiment is a crosslinked block copolymer concentrate, consisting of: about 87 to about 97 weight percent of a crosslinked block copolymer of styrene and butadiene; wherein the crosslinked block copolymer comprises 60 to about 85 weight percent of repeating units derived from styrene and about 15 to about 40 weight percent of repeating units derived from butadiene; about 3 to about 13 weight percent of a homopolystyrene; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; and optionally, the residue of a peroxide crosslinking agent; wherein the composition exhibits an extent of crosslinking characterized by an average T₁/T₂ value of 557 to 728.

Another embodiment is a crosslinked block copolymer concentrate, prepared by a method comprising: melt kneading a composition comprising about 0.01 to about 20 weight percent of a crosslinking agent and about 80 to about 99.99 weight percent of an uncrosslinked block copolymer of an alkenyl aromatic monomer and a conjugated diene to form a crosslinked block copolymer, wherein the uncrosslinked block copolymer comprises 50 to about 90 weight percent of repeating units derived from the alkenyl aromatic monomer.

Another embodiment is a crosslinked block copolymer concentrate, prepared by a method comprising: melt kneading a composition comprising about 0.05 to about 2 weight percent of dicumyl peroxide, about 5 to about 15 weight percent of a homopolystyrene, and about 80 to about 95 weight percent of an uncrosslinked block copolymer of styrene and butadiene to form a crosslinked block copolymer; wherein the uncrosslinked block copolymer comprises about 60 to about 85 weight percent of repeating units derived from styrene and about 15 to about 40 weight percent of repeating units derived from butadiene; and wherein the concentrate exhibits an extent of crosslinking characterized by an average T₁/T₂ value of 557 to 728.

Another embodiment is a method of preparing a crosslinked block copolymer concentrate, comprising: melt kneading a composition comprising about 0.01 to about 20 weight percent of a crosslinking agent and about 80 to about 99.99 weight percent of an uncrosslinked block copolymer of an alkenyl aromatic monomer and a conjugated diene to form a crosslinked block copolymer, wherein the uncrosslinked block copolymer comprises 50 to about 90 weight percent of repeating units derived from the alkenyl aromatic monomer.

Another embodiment is a method of preparing a crosslinked block copolymer concentrate, comprising: melt kneading a composition comprising about 0.05 to about 2 weight percent of dicumyl peroxide, about 5 to about 15 weight percent of a homopolystyrene, about 80 to about 95 weight percent of an uncrosslinked block copolymer of styrene and butadiene to form a crosslinked block copolymer; wherein the uncrosslinked block copolymer comprises about 60 to about 85 weight percent of repeating units derived from styrene and about 15 to about 40 weight percent of repeating units derived from butadiene; and wherein the concentrate exhibits an extent of crosslinking characterized by an average T₁/T₂ value of 557 to 728.

These and other embodiments are described in detail below.

### DETAILED DESCRIPTION OF THE INVENTION

The present inventors have conducted research aimed at improving the impact strength of blends of poly(arylene ether)s and styrenic block copolymers. Their initial efforts revealed a trade-off between transparency and toughness: composition changes that improved toughness degraded transparency, while composition changes that improved transparency degraded toughness. However, the inventors unexpectedly discovered that it was possible to break out of this trade-off and achieve improved toughness without sacrificing transparency by crosslinking a particular type styrenic block copolymer—that is by chemically joining the rubbery portion of one block copolymer molecule to the rubbery portion of another.

Thus, one embodiment is a composition comprising a poly(arylene ether) and a crosslinked block copolymer of an alkenyl aromatic monomer and a conjugated diene, wherein the crosslinked block copolymer comprises 50 to about 90 weight percent of repeating units derived from the alkenyl aromatic monomer.

The composition comprises a poly(arylene ether). In one embodiment, the poly(arylene ether) comprises repeating structural units having the formula

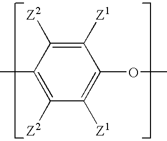

wherein for each structural unit, each Z¹ is independently halogen, unsubstituted or substituted C₁-C₁₂ hydrocarbyl with the proviso that the hydrocarbyl group is not tertiary hydrocarbyl, C₁-C₁₂ hydrocarbylthio (that is, (C₁-C₁₂ hydrocarbyl)S—), C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. However, when the hydrocarbyl residue is described as “substituted”, it may contain heteroatoms over and above the carbon and hydrogen members of the substituent residue. Thus, when specifically described as substituted, the hydrocarbyl residue may also contain halogen atoms, nitro groups, cyano groups, carbonyl groups, carboxylic acid groups, ester groups, amino groups, amide groups, sulfonyl groups, sulfoxyl groups, sulfonamide groups, sulfamoyl groups, hydroxyl groups, alkoxyl groups, or the like, and it may contain heteroatoms within the backbone of the hydrocarbyl residue.

In some embodiments, the poly(arylene ether) comprises 2,6-dimethyl-1,4-phenylene ether units, 2,3,6-trimethyl-1,4-phenylene ether units, or a combination thereof.

The poly(arylene ether) may comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(arylene ether) may be in the form of a homopolymer, a copolymer, a graft copolymer, an ionomer, or a block copolymer, as well as combinations comprising at least one of the foregoing.

The poly(arylene ether) may have a number average molecular weight of 3,000 to 40,000 atomic mass units (AMU) and a weight average molecular weight of 5,000 to 80,000 AMU, as determined by gel permeation chromatography using monodisperse polystyrene standards, a styrene divinyl benzene gel at 40° C. and samples having a concentration of 1 milligram per milliliter of chloroform. The poly(arylene ether) may have an intrinsic viscosity of about 0.05 to about 1.0 deciliter per gram (dl/g), as measured in chloroform at 25° C. Those skilled in the art understand that intrinsic viscosity of a poly(arylene ether) may increase by up to 30% on melt kneading. The above intrinsic viscosity range of 0.05 to about 1.0 deciliter per gram is intended to encompass intrinsic viscosities both before and after melt kneading to form the composition. Within the above range, the intrinsic viscosity may be at least about 0.1 dl/g, or at least about 0.2 dl/g, or at least about 0.3 dl/g. Also within the above range, the intrinsic viscosity may be up to about 0.8 dl/g, or up to about 0.6 dl/g. A blend of poly(arylene ether) resins having different intrinsic viscosities may be used.

The composition may comprise about 20 to about 99 parts by weight of the poly(arylene ether) per 100 parts by weight total of the poly(arylene ether) and the crosslinked block copolymer. Within this range, the poly(arylene ether) amount may be at least about 30 parts by weight, or at least about 50 parts by weight, or at least about 80 paits by weight. Also within this range, the poly(arylcne ether) amount may be up to about 95 parts by weight, or up to about 90 parts by weight.

In addition to the poly(arylene ether), the composition comprises a crosslinked block copolymer of an alkenyl aromatic monomer and a conjugated diene, wherein the crosslinked block copolymer comprises 50 to about 90 weight percent of repeating units derived from the alkenyl aromatic monomer. As described in detail in the working examples below, the average ratio of the spin-lattice relaxation time, T₁, to the transverse or spin-spin relaxation time, T₂, each determined by proton nuclear magnetic resonance (¹H NMR) for the poly(conjugated diene) resonances, may be used as an indicator of the degree of block copolymer crosslinking. When the analysis is conducted on a concentrate of the block copolymer, an average T₁/T₂ value greater than or equal to 530 indicates the presence of crosslinking. Conversely, an average T₁/T₂ value less than 530 indicates an uncrosslinked block copolymer (that is, a block copolymer with negligible crosslinking). For a concentrate, the T₁/T₂ value may be up to about 1,500, specifically up to about 1,000. Average T₁/T₂ values ranging from 557 to at least 728 have been observed for specific block copolymer concentrates. When the analysis is conducted on a composition comprising poly(arylene ether) and block copolymer, an average T₁/T₂ value greater than or equal to 430 indicates the presence of crosslinking. Conversely, an average T₁/T₂ value less than 430 indicates an uncrosslinked block copolymer. For a blend comprising poly(arylene ether) and crosslinked block copolymer, the T₁/T₂ value may be up to about 1,500, specifically up to about 1,000. Average T₁/T₂ values ranging from 463 to at least 767 have been observed for specific blends comprising poly(arylene ether) and crosslinked block copolymer.

In some embodiments in which the conjugated diene used to form the block copolymer is butadiene, the extent of crosslinking in the blends comprising poly(arylene ether) and crosslinked block copolymer can be expressed as an amount of residual polybutadiene aliphatic unsaturation equivalent to that present in a specified weight percent of uncrosslinked polybutadiene. This method is described in detail in the working examples below. As the extent of polybutadiene crosslinking increases, the concentration of carbon-carbon double bonds in the polybutadiene decreases. As described in detail below, the absolute concentration of carbon-carbon double bonds can be determined by monitoring the intensity of ¹H NMR resonances for the associated protons relative to an internal standard. This intensity can be expressed as the weight percent of uncrosslinked polybutadiene that would give rise to the same intensity of resonance. For example, if a blend contains 20 weight percent of an uncrosslinked styrene-butadiene block copolymer containing 30 weight percent of polybutadiene, the equivalent weight percent of uncrosslinked polybutadiene would be 20×0.30 or 6 weight percent. As another example, if a blend contained 20 weight percent of a crosslinked styrene-butadiene block copolymer containing 30 weight percent of polybutadiene in which half of the carbon-carbon double bonds have been consumed in crosslinking and other reactions, the equivalent weight percent of uncrosslinked polybutadiene would be 20×0.30×0.5 or 3 weight percent. Excellent properties have been observed in compositions having an amount of residual polybutadiene aliphatic unsaturation less than or equal to that in 5 weight percent of uncrosslinked polybutadiene, specifically less than or equal to that in 4 weight percent uncrosslinked polybutadiene, more specifically less than or equal to that in 3 weight percent uncrosslinked polybutadiene, even more specifically less than or equal to that in 2 weight percent uncrosslinked polybutadiene.

For brevity, the crosslinked block copolymer of an alkenyl aromatic monomer and a conjugated diene is sometimes referred to as the crosslinked high-styrene block copolymer or the crosslinked block copolymer. The alkenyl aromatic monomer may have the structure

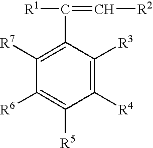

wherein R¹ and R² each independently represent a hydrogen atom, a C₁-C₈ alkyl group, or a C₂-C₈ alkenyl group; R³ and R⁷ each independently represent a hydrogen atom, a C₁-C₈ alkyl group, a chlorine atom, or a bromine atom; and R⁴-R⁶ each independently represent a hydrogen atom, a C₁-C₈ alkyl group, or a C₂-C₈ alkenyl group; or R³ and R⁴ are taken together with the central aromatic ring to form a naphthyl group, or R⁴ and R⁵ are taken together with the central aromatic ring to form a naphthyl group. Specific alkenyl aromatic monomers include, for example, styrene, chlorostyrenes such as p-chlorostyrene, and methylstyrenes such as alpha-methylstyrene and p-methylstyrene. In one embodiment, the alkenyl aromatic monomer is styrene.

The crosslinked high-styrene block copolymer comprises 50 to about 90 weight percent of repeating units derived from the alkenyl aromatic monomer, based on the total weight of the crosslinked block copolymer. Within this range, the alkenyl aromatic monomer content may be at least about 60 weight percent, or at least about 70 weight percent. Also within this range, the alkenyl aromatic monomer content may be up to about 85 weight percent, or up to about 80 weight percent. Crosslinking the high-styrene block copolymer generally has a negligible effect on the alkenyl aromatic monomer content, so the alkenyl aromatic monomer content of the crosslinked block copolymer may be approximated as that of the uncrosslinked block copolymer from which it was prepared.

The conjugated diene used to prepare the crosslinked high-styrene block copolymer may be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In one embodiment, the conjugated diene is 1,3-butadiene, 2-methyl-1,3-butadiene, or a combination thereof.

The crosslinked high-styrene block copolymer is prepared by crosslinking an uncrosslinked high-styrene block copolymer. In one embodiment, the uncrosslinked high-styrene block copolymer has a linear structure (including a tapered linear structure), a grafted structure, or a radial teleblock structure. Suitable linear triblock copolymers include, for example, those sold by Kraton Polymers as KX220 and KX222. In one embodiment, the uncrosslinked high-styrene block copolymer has a radial teleblock structure. Radial teleblock copolymers comprise segments or “blocks” which themselves comprise at least one conjugated diene polymer block, at least one alkenyl aromatic polymer block, and a coupling agent. These materials are sometimes referred to as “branched” polymers and are known in the art. For example, they are generally described in U.S. Pat. No. 4,097,550 to Haaf et al.; Marrs et al., ADHESIVES AGE, December, 1971, pages 15-20; and Haws et al., RUBBER WORLD, January, 1973, pages 27-32. Radial teleblock copolymers are commercially available as, for example, K-RESIN® KR01, KR03, and KR05 from Chevron Phillips Chemical Company.

In one embodiment, the uncrosslinked high-styrene block copolymer has a tapered linear structure (that is, it is a “tapered block copolymer”). Those of ordinary skill in the polymer arts understand the concept of “tapering”. Furthermore, techniques for achieving tapered polymers or copolymers are well-known in the art. Examples of references that relate to tapered block polymers are U.S. Pat. Nos. 4,948,832 to Ostermayer et al., U.S. Pat. No. 4,939,207 to Fasulo et al., U.S. Pat. No. 4,918,145 to Dougherty et al.; U.S. Pat. No. 4,914,248 to Kitagawa et al., and U.S. Pat. No. 4,913,971 to Beck et al. A tapered block copolymer may include both random and block structural units, with the weight ratio of random to block usually being about 1.5:1 to about 4:1, more specifically about 2.5:1 to about 3:1. Some of the suitable materials of this type contain a block of the alkenyl aromatic polymer having a molecular weight of about 10,000 to about 30,000, followed by a block of the polymerized conjugated diene having a molecular weight of about 25,000 to about 65, 000, which itself is linked to a random block of alkenyl aromatic-conjugated diene polymer (for example, a random block of styrene-butadiene) having a molecular weight of about 30,000 to about 50,000. The random block may be attached at its opposite end to another alkenyl aromatic polymeric block, usually having a molecular weight of about 30,000 to about 50,000. Tapered block copolymers are commercially available as, for example, FINACLEAR® 520 and 540 from Total Petrochemicals.

The uncrosslinked high-styrene block copolymer may, optionally, be partially hydrogenated, as long as at least about 20 percent, specifically at least 30 percent, more specifically at least 50 percent, even more specifically at least 70 percent, of the initial aliphatic unsaturation remains. For example, the uncrosslinked high-styrene block copolymer may be a styrene-(butylene-butadiene)-styrene triblock copolymer obtained on selectively hydrogenating a styrene-butadiene-styrene triblock copolymer. Other selectively hydrogenated block copolymers are described, for example, in U.S. Pat. No. 6,872,777 to Adedeji et al. In some embodiments, the uncrosslinked high-styrene block copolymer is unhydrogenated.

There is no particular limitation on the method used to crosslink the uncrosslinked high-styrene block copolymer. Any agent known to form chemical crosslinks between aliphatically unsaturated groups in the poly(conjugated diene) portion of the block copolymer may be used. For example, the crosslinked high-styrene block copolymer may comprise the reaction product of an uncrosslinked high-styrene block copolymer and a crosslinking agent chosen from sulfur, sulfur donor compounds, peroxide compounds, hydroperoxide compounds, azo compounds, electromagnetic radiation capable of generating free radicals, electron beams, and combinations thereof. The block copolymer may be crosslinked either before or after being blended with the poly(arylene ether).

In one embodiment, the crosslinking agent is a peroxide compound, a hydroperoxide compound, or a mixture thereof. Suitable peroxide and hydroperoxide compounds include, for example, t-butyl hydroperoxide, di-t-butyl peroxide, benzoyl peroxide, 2,4-dichlorobenzoyl peroxide, lauroyl peroxide, t-butyl peracetate, 2,2-bis(t-butylperoxy)butane, 1,1-bis(t-butylperoxy)butane, dicumyl peroxide, cumene hydroperoxide, 2,4-pentanedioneperoxide, 2,5-dimethylhexane-2,5-diperoxy benzoate, 2,5-dimethyl-2,4-di(t-butylperoxy)hexane, 2,5-bis(t-butylperoxy)-2,5-dimethyl-3-hexyne, bis[1-(t-butylperoxy)-1-methylethyl]benzene, methylethylketone peroxide, di-t-butyl diperoxyphthalate, t-butyl peroxybenzoate, dicyclohexyl peroxydicarbonate, di-(4-t-butyl-cyclohexyl) peroxydicarbonate, n-butyl 4,4-bis(t-butylperoxy)valerate, t-butylperoxy isobutyrate, t-butylperoxy isopropyl carbonate, t-butyl peroctoate, α,α′-bis(t-butylperoxy)-m-diisopropylbenzene, α,α′-bis(t-butylperoxy)-p-diisopropylbenzene, 1,1-di-t-butylperoxide-3,5,5-trimethylcyclohexane, and the like, and combinations thereof. In one embodiment, the crosslinking agent is dicumyl peroxide. The crosslinking agent is used in an amount effective to crosslink the block copolymer. The amount of crosslinking agent is typically about 1 to about 50 parts by weight per 100 parts by weight of the uncrosslinked block copolymer. Within this range, the crosslinking agent amount may be at least about 2 parts by weight, or at least about 5 parts by weight. Also within this range, the crosslinking agent amount may be up to about 35 parts by weight, or up to about 20 parts by weight.

In one embodiment, the crosslinking agent is sulfur or a sulfur donor compound. Methods for crosslinking polymers of conjugated dienes, including natural rubber, with elemental sulfur and sulfur donor compounds are known in the art. See, for example, U.S. Pat. Nos. 3,633 to Goodyear et al. and U.S. Pat. No. 6,695,718 to Nesbitt. Suitable sulfur donors include, for example, 4,4′-dithiodimorpholine, 4-morpholinyl-2-benzothiazole disulfide (MBSS), dipentamethylenethiuram hexasulfide (DPTH), caprolactam disulfide, thiuram disulfides, and combinations thereof. The sulfur or sulfur donor compound may, optionally, be used in the presence of a vulcanization accelerator such as, for example, mercaptobenzothiazoles, sulfenamides, dithiocarbamates, thiuram sulfides, guanidines, thioureas, xanthates, dithiophosphates, aldehyde-amines, and combinations thereof.

The crosslinking agent may also be an azo compound such as, for example, azobisisobutyronitrile (AIBN) or 1,1′-azobis(cyclohexanecarbonitrile).

It has been found that the composition comprising the poly(arylene ether) and the crosslinked block copolymer may be conveniently prepared by first preparing a crosslinked block copolymer concentrate, then blending that concentrate with the poly(arylene ether) and any optional components. Thus, one embodiment is a crosslinked block copolymer concentrate, comprising: at least 80 weight percent of a crosslinked block copolymer of an alkenyl aromatic monomer and a conjugated diene; wherein the crosslinked block copolymer comprises 50 to about 90 weight percent of repeating units derived from the alkenyl aromatic monomer. As noted above, an average T₁/T₂ value greater than or equal to 530 indicates the presence of crosslinking in a concentrate. Conversely, an average T₁/T₂ value less than 530 indicates an uncrosslinked block copolymer in the concentrate. Average T₁/T₂ values ranging from 557 to at least 728 have been observed for the block copolymer concentrates.

The crosslinked block copolymer concentrate may be prepared by reaction of an uncrosslinked block copolymer with any of the crosslinking agents described above. In some embodiments, the reaction of the uncrosslinked block copolymer and the crosslinking agent is conduct via melt kneading these reactants. Apparatus suitable for preparing an intimate blend via melt kneading includes, for example, a two-roll mill, a Banbury mixer, and a single-screw or twin-screw extruder. In some embodiments, melt kneading comprises using a twin-screw extruder. In some embodiments, the concentrate is prepared by a method comprising melt kneading a composition comprising about 0.01 to about 20 weight percent of a crosslinking agent and about 80 to about 99.99 weight percent of an uncrosslinked block copolymer of an alkenyl aromatic monomer and a conjugated diene to form a crosslinked block copolymer, wherein the uncrosslinked block copolymer comprises 50 to about 90 weight percent of repeating units derived from the alkenyl aromatic monomer. In some embodiments, the melt kneaded composition may comprise, in addition to the crosslinking agent and the block copolymer, about 1 to about 20 weight percent of a polymeric carrier for the crosslinking agent. Homopolystyrene has been found to be a suitable polymeric carrier. Thus, one embodiment is a crosslinked block copolymer concentrate, consisting of at least 80 weight percent of a crosslinked block copolymer of an alkenyl aromatic monomer and a conjugated diene; wherein the crosslinked block copolymer comprises 50 to about 90 weight percent of repeating units derived from the alkenyl aromatic monomer; optionally, about 1 to about 20 weight percent of a homopolystyrene; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; and optionally, the residue of a crosslinking agent selected from the group consisting of sulfur, sulfur donor compounds, peroxide compounds, hydroperoxide compounds, azo compounds, electromagnetic radiation capable of generating free radicals, electron beams, and combinations thereof. Another embodiment is a crosslinked block copolymer concentrate, comprising: about 87 to about 97 weight percent of a crosslinked block copolymer of styrene and butadiene; wherein the crosslinked block copolymer comprises 60 to about 85 weight percent of repeating units derived from styrene and about 15 to about 40 weight percent of repeating units derived from butadiene; and about 3 to about 13 weight percent of a homopolystyrene; wherein the composition exhibits an extent of crosslinking characterized by an average T₁/T₂ value of 557 to 728. Yet another embodiment is a crosslinked block copolymer concentrate, consisting of: about 87 to about 97 weight percent of a crosslinked block copolymer of styrene and butadiene; wherein the crosslinked block copolymer comprises 60 to about 85 weight percent of repeating units derived from styrene and about 15 to about 40 weight percent of repeating units derived from butadiene; about 3 to about 13 weight percent of a homopolystyrene; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; and optionally, the residue of a peroxide crosslinking agent; wherein the composition exhibits an extent of crosslinking characterized by an average T₁/T₂ value of 557 to 728.

The crosslinked copolymer concentrate may be described in terms of the method used to make it. For example, one embodiment is a crosslinked block copolymer concentrate, prepared by a method comprising: melt kneading a composition comprising about 0.01 to about 20 weight percent of a crosslinking agent and about 80 to about 99.99 weight percent of an uncrosslinked block copolymer of an alkenyl aromatic monomer and a conjugated diene to form a crosslinked block copolymer, wherein the uncrosslinked block copolymer comprises 50 to about 90 weight percent of repeating units derived from the alkenyl aromatic monomer. The crosslinking agent may be, for example, sulfur, a sulfur donor compound, a peroxide compound, a hydroperoxide compound, an azo compound, or a combination thereof. In some embodiments, the crosslinking agent is a peroxide compound. In some embodiments, the crosslinking agent is dicumyl peroxide.

One embodiment is a crosslinked block copolymer concentrate, prepared by a method comprising: melt kneading a composition comprising about 0.05 to about 2 weight percent of dicumyl peroxide, about 5 to about 15 weight percent of a homopolystyrene, and about 80 to about 95 weight percent of an uncrosslinked block copolymer of styrene and butadiene to form a crosslinked block copolymer; wherein the uncrosslinked block copolymer comprises about 60 to about 85 weight percent of repeating units derived from styrene and about 15 to about 40 weight percent of repeating units derived from butadiene; and wherein the concentrate exhibits an extent of crosslinking characterized by an average T₁/T₂ value of 557 to 728.

One embodiment is a method of preparing a crosslinked block copolymer concentrate, comprising: melt kneading a composition comprising about 0.01 to about 20 weight percent of a crosslinking agent and about 80 to about 99.99 weight percent of an uncrosslinked block copolymer of an alkenyl aromatic monomer and a conjugated diene to form a crosslinked block copolymer, wherein the uncrosslinked block copolymer comprises 50 to about 90 weight percent of repeating units derived from the alkenyl aromatic monomer.

One embodiment is a method of preparing a crosslinked block copolymer concentrate, comprising: melt kneading a composition comprising about 0.05 to about 2 weight percent of dicumyl peroxide, about 5 to about 15 weight percent of a homopolystyrene, about 80 to about 95 weight percent of an uncrosslinked block copolymer of styrene and butadiene to form a crosslinked block copolymer; wherein the uncrosslinked block copolymer comprises about 60 to about 85 weight percent of repeating units derived from styrene and about 15 to about 40 weight percent of repeating units derived from butadiene; and wherein the concentrate exhibits an extent of crosslinking characterized by an average T₁/T₂ value of 557 to 728.

The crosslinked high-styrene block copolymer may be used in an amount of about 1 to about 80 parts by weight of the crosslinked block copolymer per 100 parts by weight total of the poly(arylene ether) and the crosslinked block copolymer. Within this range, the crosslinked block copolymer amount may be at least about 5 parts by weight, or at least about 10 parts by weight. Also within this range, the crosslinked block copolymer amount may be up to about 70 parts by weight, or up to about 50 parts by weight, or up to about 30 parts by weight, or up to about 20 parts by weight.

In addition to the poly(arylene ether) and the crosslinked high-styrene block copolymer, the composition may, optionally, further comprise an uncrosslinked high-styrene block copolymer, that is, an uncrosslinked block copolymer of an alkenyl aromatic monomer and a conjugated diene wherein the uncrosslinked block copolymer comprises 50 to about 90 weight percent of repeating units derived from the alkenyl aromatic monomer, based on the total weight of the uncrosslinked high-styrene block copolymer. Within this range, the alkenyl aromatic monomer content may be at least about 60 weight percent, or at least about 70 weight percent. Also within this range, the alkenyl aromatic monomer content may be up to about 85 weight percent, or up to about 80 weight percent. The uncrosslinked high-styrene block copolymer may be present in the composition as unreacted starting material from the crosslinking reaction, or it may be separately added to the composition.

In addition to the poly(arylene ether) and the crosslinked high-styrene block copolymer, the composition may, optionally, further comprise a homopolystyrene (that is, a homopolymer of styrene). The homopolystyrene can serve not only to adjust the properties of the composition, but also as a convenient carrier for the crosslinking agent in embodiments in which the crosslinking agent is melt kneaded with the uncrosslinked block copolymer. When present, the homopolystyrene may be used in an amount of about 0.1 to about 100 parts by weight of a homopolystyrene per 100 parts by weight total of the poly(arylene ether) and the crosslinked block copolymer. Within this range, the homopolystyrene amount may be at least about 0.5 part by weight, or at least 1 part by weight. Also within this range, the homopolystyrene may be used in an amount of up to about 50 parts by weight, or up to about 30 parts by weight. In some embodiments in which the homopolystyrene is used primarily or exclusively as a carrier for the crosslinking agent, the homopolystyrene amount may be about 0.1 to about 5 parts by weight per 100 parts by weight total of the poly(arylene ether) and the crosslinked block copolymer.

In addition to the poly(arylene ether) and the high-styrene crosslinked block copolymer, the composition may, optionally, further comprise a low-styrene crosslinked block copolymer, that is, a crosslinked block copolymer of an alkenyl aromatic monomer and a conjugated diene; wherein the crosslinked block copolymer comprises about 10 to less than 50 weight percent of repeating units derived from the alkenyl aromatic monomer, wherein the weight percent is based on the total weight of the low-styrene crosslinked block copolymer. Within the range of about 10 to less than 50 weight percent, the alkenyl aromatic monomer content may be at least about 20 weight percent, or at least 30 weight percent. Also within this range, the alkenyl aromatic monomer content may be up to about 45 weight percent, or up to about 40 weight percent.

The composition may, optionally, further comprise a filler. The filler may be, for example, a particulate filler or a reinforcing filler. Suitable fillers include, for example, alumina, silica (including fused silica and crystalline silica), boron nitride (including spherical boron nitride), aluminum nitride, silicon nitride, magnesia, magnesium silicate, glass fibers, glass mat, carbon black, carbon nanofibers (including single-wall and multi-wall carbon nanotubes), nanofillers (including those described in U.S. Patent Application Serial No. US 2004/0122153 of Guo et al.), and the like, and combinations thereof. In some embodiments, the filler is one that does not detract from the desirable optical properties of the composition. Thus, in some embodiments, the filler comprises less than 5 weight percent of particles having any dimension greater than 200 nanometers. The filler may be substantially free of particles having any dimension greater than 200 nanometers. Suitable fillers may include, for example, nanotalcs, fumed silicas, and nanoclays. When present, the inorganic filler may be used in an amount of about 1 to about 70 weight percent, based on the total weight of the composition. In some embodiments, the composition comprises less than 50 weight percent filler, or less than 30 weight percent filler, or less than 10 weight percent filler. In some embodiments, the composition is free of filler (that is, no filler is intentionally added).

The composition may, optionally, further comprise various additives known in the thermoplastics art. For example, the composition may, optionally, further comprise an additive chosen from stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and the like, and combinations thereof. Additives may be added in amounts that do not unacceptably detract from the desired optical and physical properties of the composition. Such amounts may be determined by a skilled artisan without undue experimentation.

In one embodiment, the composition may exclude or be substantially free of components other than those described above. For example, the composition may be substantially free of other polymeric materials, such as polyamides, polyesters, polycarbonates, and polyolefins. As another example, the composition may be substantially free of reagents used to functionalize poly(arylene ether)s such as, for example, maleic anhydride and vinyl silanes. As yet another example, the composition may be substantially free of polymerizable monomers such as, for example, monomers comprising a polymerizable carbon-carbon double bond (for example, the “unsaturated aliphatic hydrocarbon” of U.S. Pat. No. 5,143,891 to Abe et al.). As still another example, the composition may be substantially free of block copolymers derived from monomers other than the alkenyl aromatic monomer and the conjugated diene (such as maleic-anhydride functionalized block copolymers). As used herein, the term “substantially free” means that the composition comprises less than 0.5 weight percent of the specified component. More specifically, the composition may comprise less than 0.1 weight percent of the specified component, or none of the specified component may be intentionally added.

The composition exhibits various improved properties relative to compositions in which the block copolymer is not crosslinked. For example, the composition after molding may exhibit one or more of the following properties: a reverse notched Izod value of at least 1000 Joules per meter, measured at 23° C. according to ASTM D 256-06; a reverse notched Izod value of about 1000 to about 1850 Joules per meter, measured at 23° C. according to ASTM D 256-06; a Dynatup Total Energy impact strength of at least 25 Joules, measured at 23° C. according to ASTM D 3763-06; a Dynatup Total Energy impact strength of about 25 to about 45 Joules, measured at 23° C. according to ASTM D 3763-06; a percent transmittance of at least 60 percent, measured at 23° C. and a thickness of 3.2 millimeters according to ASTM D 1003-00; and a percent transmittance of about 60 to about 85 percent, measured at 23° C. and a thickness of 3.2 millimeters according to ASTM D 1003-00. Within the above Dynatup Total Energy range, that property value may be at least about 30 Joules, or at least about 35 Joules. Within the above percent transmittance range, that property value may be at least about 70 percent, or at least about 80 percent.

One embodiment is a composition, consisting of: a poly(arylene ether); a crosslinked block copolymer of an alkenyl aromatic monomer and a conjugated diene; wherein the crosslinked block copolymer comprises 50 to about 90 weight percent of repeating units derived from the alkenyl aromatic monomer; optionally, a homopolystyrene; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

One embodiment is a composition, comprising: a poly(arylene ether) comprising 2,6-dimethyl-1,4-phenylene ether units and having an intrinsic viscosity of about 0.3 to about 0.6 deciliter per gram, measured at 25° C. in chloroform; and a crosslinked block copolymer of an alkenyl aromatic monomer and a conjugated diene; wherein the crosslinked block copolymer comprises about 60 to about 85 weight percent of repeating units derived from the alkenyl aromatic monomer; wherein the alkenyl aromatic monomer is styrene; wherein the conjugated diene is 1,3-butadiene, 2-methyl-1,3-butadiene, or a combination thereof; wherein the crosslinked block copolymer comprises the reaction product of an uncrosslinked block copolymer and a peroxide compound; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767.

One embodiment is a composition, consisting of: a poly(arylene ether) comprising 2,6-dimethyl-1,4-phenylene ether units and having an intrinsic viscosity of about 0.3 to about 0.6 deciliter per gram, measured at 25° C. in chloroform; and a crosslinked block copolymer of an alkenyl aromatic monomer and a conjugated diene; wherein the crosslinked block copolymer comprises about 60 to about 85 weight percent of repeating units derived from the alkenyl aromatic monomer; wherein the alkenyl aromatic monomer is styrene; wherein the conjugated diene is 1,3-butadiene, 2-methyl-1,3-butadiene, or a combination thereof; wherein the crosslinked block copolymer comprises the reaction product of an uncrosslinked block copolymer and a peroxide compound; optionally, a homopolystyrene; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767.

One embodiment is a composition, comprising: about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer; wherein the alkenyl aromatic monomer is styrene; wherein the conjugated diene is 1,3-butadiene; wherein the crosslinked tapered block copolymer comprises the reaction product of an uncrosslinked tapered teleblock copolymer and dicumyl peroxide; wherein all parts by weight are based on 100 parts by weight total of the poly(arylene ether) and the crosslinked tapered block copolymer; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

One embodiment is a composition, consisting of: about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer; wherein the alkenyl aromatic monomer is styrene; wherein the conjugated diene is 1,3-butadiene; wherein the crosslinked tapered block copolymer comprises the reaction product of an uncrosslinked tapered teleblock copolymer and dicumyl peroxide; optionally, about 0.1 to about 100 parts by weight of a homopolystyrene per 100 parts by weight total of the poly(arylene ether) and the crosslinked block copolymer; optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer; optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof; wherein all parts by weight are based on 100 parts by weight total of the poly(arylene ether) and the crosslinked tapered block copolymer; wherein the composition after molding exhibits a reverse notched Izod value of about 1000 to about 1850 Joules per meter, measured at 23° C. according to ASTM D 256, a Dynatup Total Energy impact strength of about 25 to about 45 Joules, measured at 23° C. according to ASTM D 3763, and a percent transmittance of about 60 to about 85 percent, measured at 23° C. and a thickness of 3.2 millimeters according to ASTM D 1003; and wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

The composition may be prepared by any method capable of forming an intimate blend of the poly(arylene ether) and the crosslinked high-styrene block copolymer. As noted above, the high-styrene block copolymer may be crosslinked before or after blending with the poly(arylene ether). However, there appear to be some physical property advantages to crosslinking the high-styrene block copolymer before it is blended with the poly(arylene ether). One method of preparing the crosslinked high-styrene block copolymer comprises melt kneading an uncrosslinked high-styrene block copolymer with a crosslinking agent. One method of forming an intimate blend of the poly(arylene ether) and the crosslinked high-styrene block copolymer comprises melt kneading the poly(arylene ether) and the crosslinked high-styrene block copolymer. Apparatus suitable for preparing an intimate blend via melt kneading includes, for example, a two-roll mill, a Banbury mixer, and a single-screw or twin-screw extruder. In one embodiment, melt kneading comprises using a twin-screw extruder.

One embodiment is a method of forming a thermoplastic composition, comprising: melt kneading a poly(arylene ether) and a crosslinked block copolymer of an alkenyl aromatic monomer and a conjugated diene; wherein the crosslinked block copolymer comprises 50 to about 90 weight percent of repeating units derived from the alkenyl aromatic monomer.

One embodiment is a method of forming a thermoplastic composition, comprising: melt kneading a crosslinking agent and an uncrosslinked block copolymer of an alkenyl aromatic monomer and a conjugated diene to form a crosslinked block copolymer; wherein the uncrosslinked block copolymer comprises 50 to about 90 weight percent of repeating units derived from the alkenyl aromatic monomer; and melt kneading a poly(arylene ether) with the crosslinked block copolymer.

Another embodiment is an article comprising any of the above-described compositions. For example, an article may comprise a film, sheet, molded object, or composite, wherein the film, sheet, molded object or composite comprises at least one layer comprising the composition. Articles may be prepared from the composition using fabrication methods known in the art, including, for example, single layer and multilayer foam extrusion, single layer and multilayer sheet extrusion, injection molding, blow molding, extrusion, film extrusion, profile extrusion, pultrusion, compression molding, thermoforming, pressure forming, hydroforming, vacuum forming, foam molding, and the like. Combinations of the foregoing article fabrication methods may be used. Articles for which the composition may be used include, for example, heat-resistant product packaging, appliance and business machine housings, cell phone holders, printer ink cartridges, automotive parts, and electrical apparatus housings.

The invention is further illustrated by the following non-limiting examples.

### EXAMPLES 1-9, COMPARATIVE EXAMPLES 1-3

All compositions were prepared by a two-step process. The first step was the preparation of a concentrate comprising a block copolymer in either uncrosslinked form (comparative examples) or crosslinked form (inventive examples). The second step was blending of a concentrate with a poly(arylene ether) resin. A tapered styrene-butadiene block copolymer (“SBC”) having a styrene content of 72 weight percent, a density at 23° C. of 1.01 gram per cubic centimeter measured according to ASTM D 792-A, and a melt flow index of 7.5 gram per 10 minutes, measured at 200° C. and 5 kilogram load according to ASTM D 1238 G, was obtained as FINACLEAR 520 from Total Petrochemicals. A granular homopolystyrene (“xPS”) having a number average molecular weight of about 65,000 atomic mass units and a weight average molecular weight of about 105,000 atomic mass units was obtained as Novacor 2272 from Nova Chemical. Dicumyl peroxide (“DCP”) was obtained as LUPEROX 505R from Elf Atochem. A poly(2,6-dimethyl-1,4-phenylene ether) (“PPE”) having an intrinsic viscosity of about 0.46 deciliter per gram in chloroform at 25° C. was obtained from GE Plastics.

The general procedure for preparation of crosslinked rubber concentrates is as follows. Concentrate compositions are detailed in Table 1, where all component amounts are expressed in parts by weight. The transparent rubber (for example, FINACLEAR 520) is preextruded in the presence of a peroxide crosslinker (for example, dicumyl peroxide). The peroxide is dry pre-blended in ground homopolystyrene to improve dispersion. In the control concentrate, Comparative Example 1, the rubber was extruded with polystyrene in the absence of a peroxide crosslinker. The polystyrene+peroxide pre-blend and rubber are fed separately but simultaneously to the feed throat of a 30-millimeter, twin-screw extruder operating at 350 rotations per minute with barrel temperatures from feed throat to die of 180° C., 200° C., 230° C., and 230° C. The extruder has fairly intensive mixing in barrels 2 to 4 with relatively mild mixing in barrel 9. The extrudate is cooled and pelletized.

TABLE 1

| Component | C. Ex. 1 | Ex. 1 | Ex. 2 | Ex. 3 |
|---|---|---|---|---|
| SBC | 90 | 90 | 90 | 90 |
| xPS | 10 | 10 | 10 | 10 |
| DCP | 0 | 0.2 | 0.4 | 0.6 |

The general procedure for preparation of final compositions is as follows. The compositions of Examples 4-13 and Comparative Examples 2-4 are detailed in Table 2, where all component amounts are expressed in parts by weight. The poly(arylene ether) is added in the feed throat. The rubber concentrate pellet is added downstream via a stuffer at barrel 7 of 10, where the poly(arylene ether) is melted. (It has been observed that adding crosslinked rubber at the feed throat may be associated with reduced impact strength of the composition.) The extruder configuration is the same as that for preparation of concentrates except that (1) the stuffer at barrel 7 is employed, (2) the barrel temperatures from the feed throat to die are 250° C., 290° C., 300° C., and 300° C., and (3) a vacuum vent providing 20-25 inches of water vacuum at barrel 9 is employed.

Property values for each composition are presented in Table 2. Notched Izod impact strength and reversed notched Izod impact strengths, expressed in Joules per meter (J/m), were measured at 23° C. according to ASTM D 256-05, Methods A and E, respectively, using a 0.907 kilogram (2.00 pound) hammer, and specimens having a notch such that at least 1.02 centimeters (0.4 inch) of the original 1.27 centimeters (0.5 inch) depth remained under the notch; the specimens were conditioned for 24 hours at 23° C. after notching. Dynatup energy to maximum load, energy to failure, total energy, and maximum load were measured according ASTM D 3763-06 at 23° C. using an Instron Dynatup Model 8250. Disk-shaped Dynatup samples were prepared by injection molding and had a diameter of 10 centimeters and a thickness of 0.32 centimeter. Dynatup testing used a velocity of 3.3 meters/minute. Dynatup total energy was calculated using the highest point on the load versus displacement curve. All Dynatup energy values are expressed in Joules (J), and the Dynatup maximum load is expressed in Newtons (N). Heat deflection temperature was measured according to ASTM D 648-06, Method B on injection molded specimens having a width of 3.20 millimeters and a depth of 12.80 millimeters. Specimens were conditioned for 24 hours at 23° C. before testing. For heat deflection testing, samples were immersed in silicone oil, which was initially at less than 30° C., and heated at a rate of 2° C. per minute. The standard deviation for each property value represents evaluation of three samples per test.

The results in Table 2 show significant improvements in at least one measured property—and often in all measured properties—for inventive Examples 4-12 relative to the corresponding Comparative Examples 2-4. For example, relative to Comparative Example 2 with uncrosslinked block copolymer, Example 6 exhibits increased notched Izod impact strength, increased reverse notched Izod impact strength, dramatically increased Dynatup energy to maximum load and energy to failure and total energy, ductile rather than brittle failure in the Dynatup test, and increased heat deflection temperature. Such a dramatic improvement in various ductility properties and heat resistance was unexpected.

TABLE 2

| | | | |
|---|---|---|---|
| C. Ex. 2 | Ex. 4 | Ex. 5 | Ex. 6 |

Compositions

| | | | | |
|---|---|---|---|---|
| PPE | 90 | 90 | 90 | 90 |
| Concentrate 1 | 10 | 0 | 0 | 0 |
| Concentrate 2 | 0 | 10 | 0 | 0 |
| Concentrate 3 | 0 | 0 | 10 | 0 |
| Concentrate 4 | 0 | 0 | 0 | 10 |

Properties

| N. Izod (J/m) | 46.0 ± 3.8 | 46.8 ± 2.3 | 46.4 ± 6.3 | 53.3 ± 6.5 |
|---|---|---|---|---|
| failure mode | brittle | brittle | brittle | brittle |
| Rev. N. Izod (J/m) | 715 ± 156 | 977 ± 90 | 1850 ± 333 | 1409 ± 206 |
| failure mode | brittle | brittle | brittle | brittle |
| Energy to max. load (J) | 3.82 ± 0.94 | 25.4 ± 23.3 | 32.1 ± 23.6 | 34.7 ± 26.4 |
| Energy to failure (J) | 4.72 ± 1.59 | 28.8 ± 23.8 | 35.9 ± 23.5 | 38.4 ± 26.9 |
| failure mode | brittle | ductile | ductile | ductile |
| Total energy (J) | 5.04 ± 1.42 | 28.9 ± 23.8 | 36.1 ± 23.3 | 38.8 ± 26.4 |
| Max. load (N) | 1.32 ± 0.19 | 3.80 ± 2.22 | 4.60 ± 2.26 | 4.66 ± 2.45 |
| Heat deflection temp. (° C.) | 158 ± 5 | 163 ± 1 | 165 ± 0.5 | 166 ± 1 |
| | C. Ex. 3 | Ex. 7 | Ex. 8 | Ex. 9 |

Compositions

| | | | | |
|---|---|---|---|---|
| PPE | 80 | 80 | 80 | 80 |
| Concentrate 1 | 20 | 0 | 0 | 0 |
| Concentrate 2 | 0 | 20 | 0 | 0 |
| Concentrate 3 | 0 | 0 | 20 | 0 |
| Concentrate 4 | 0 | 0 | 0 | 20 |

Properties

| N. Izod (J/m) | 37.1 ± 3.4 | 45.0 ± 1.5 | 49.4 ± 3.7 | 51.8 ± 4.9 |
|---|---|---|---|---|
| failure mode | brittle | brittle | brittle | brittle |
| Rev. N. Izod (J/m) | 509 ± 103 | 1411 ± 345 | 1155 ± 62 | 1220 ± 370 |
| failure mode | brittle | brittle | brittle | brittle |
| Energy to max. load (J) | 1.76 ± 0.37 | 31.2 ± 22.9 | 35.8 ± 23.5 | 24.7 ± 23.7 |
| Energy to failure (J) | 2.14 ± 0.30 | 34.2 ± 24.3 | 38.6 ± 25.6 | 26.9 ± 22.9 |
| failure mode | brittle | ductile | ductile | ductile |
| Total energy (J) | 5.64 ± 2.77 | 34.3 ± 24.3 | 38.8 ± 25.3 | 29.5 ± 23.1 |
| Max. load (N) | 1.05 ± 0.15 | 4.55 ± 2.07 | 5.00 ± 2.12 | 3.8 ± 2.4 |
| Heat deflection temp. (° C.) | 139 ± 1 | 152 ± 1 | 146 ± 1 | 149 ± 3 |
| | C. Ex. 4 | Ex. 10 | Ex. 11 | Ex. 12 |

Compositions

| | | | | |
|---|---|---|---|---|
| PPE | 70 | 70 | 70 | 70 |
| Concentrate 1 | 30 | 0 | 0 | 0 |
| Concentrate 2 | 0 | 30 | 0 | 0 |
| Concentrate 3 | 0 | 0 | 30 | 0 |
| Concentrate 4 | 0 | 0 | 0 | 30 |

Properties

| | | | | |
|---|---|---|---|---|
| N. Izod (J/m) | 29.1 ± 3.6 | 42.9 ± 6.4 | 47.3 ± 4.0 | 47.1 ± 3.8 |
| failure mode | brittle | brittle | brittle | brittle |
| Rev. N. Izod (J/m) | 632 ± 35 | 1248 ± 161 | 1003 ± 254 | 1110 ± 133 |
| failure mode | brittle | brittle | brittle | brittle |
| Energy to max. load (J) | 6.92 ± 6.03 | 33.7 ± 24.9 | 38.8 ± 11.8 | 20.3 ± 14.1 |
| Energy to failure (J) | 7.52 ± 6.37 | 38.0 ± 27.4 | 43.6 ± 13.4 | 23.8 ± 16.3 |
| failure mode | brittle | ductile | ductile | ductile |
| Total energy (J) | 8.70 ± 5.59 | 38.0 ± 27.5 | 45.9 ± 15.3 | 26.1 ± 19.6 |
| Max. load (N) | 2.08 ± 1.14 | 4.29 ± 2.25 | 5.29 ± 0.67 | 3.69 ± 1.73 |
| Heat deflection temp. (° C.) | 127 ± 0.4 | 134 ± 1 | 133 ± 1 | 135 ± 0.3 |

### EXAMPLES 13-17, COMPARATIVE EXAMPLE 5

These examples demonstrate the preparation and characterization of six rubber concentrates. These concentrates had the initial compositions presented in Table 3 and were prepared according to the general procedure for preparation of crosslinked rubber concentrates described above.

The rubber concentrates so obtained were analyzed by proton nuclear magnetic resonance spectroscopy (¹H NMR) and Fourier transform infrared spectroscopy (FTIR) to determine the extent of rubber crosslinking. A ¹H NMR method was used to determine the ratio of the longitudinal or spin-lattice relaxation time, T₁, to the transverse or spin-spin relaxation time, T₂. A different ¹H NMR method was used to determine the percentage of residual polybutadiene double bonds. Each of these methods is described in detail below.

The ¹H NMR procedure used to determine T₁ values, T₂ values, and their ratio was as follows. Initially, it should be noted that the polystyrene component of the block copolymer is well below its glass transition temperature and therefore gives rise to resonances too broad to detect by solution NMR methods. In contrast, the polybutadiene portion of the sample is well above its glass transition temperature, and therefore has much narrower lines that are easier to detect. The ¹H NMR procedure used to determine T₁ values, T₂ values, and their ratio was as follows. All samples (portionis of pellets or molded parts) for T₁/T₂ measurements were run in the solid state (but NOT, however, using solid state NMR techniques). No sample preparation was required, except for ensuring that the sample would fit into a standard 5 millimeter NMR tube. In order to minimize T₂ artifacts, samples were not spun. Tuning of the probe was performed prior to analysis. For best probe performance, a representative sample is placed in the probe during the tuning operation. In addition, spectrometer lock power and lock gain are turned off. The spectral window was 30 kilohertz and included resonances for hydrogen atoms attached to sp³ and sp² carbons. The T₁/T₂ procedure required no sample shimming. T₁ data were obtained with the standard 180°-τ-90° inversion recovery pulse sequence and T₂ data were obtained with the Carr-Purcell Meiboom-Gill pulse sequence. Tau (τ) values are listed below. Eight scans were accumulated for each τ-value with a pulse delay of 3 seconds. For typical samples, T₁ values were less than 600 milliseconds (ms), so no dummy scans were required. For the T₁ experiment, ten different τ-values were obtained: 10 ms, 20 ms, 50 ms, 100 ms, 160 ms, 250 ms, 400 ms, 630 ms, 1.0 second, and 1.5 seconds. For the T₂ experiment, eight different r-values were obtained: 100 microseconds (μs), 180 μs, 320 μs, 560 μs, 1.0 ms, 1.8 ms, 3.2 ms, and 5.6 ms. T₁ and T₂ analysis was performed using T₁ and T₂ macros that were part of the Varian software Version 6.1 Revision C provided with the NMR test equipment (Model: Mercury Plus). Once the T₁ and T₂ values were calculated for each of the two observable polybutadiene resonances, the average T₁ value was divided by the average T₂ value to produce the final result. Values of T₁ and T₂ for protons attached to sp³ and sp² hybridized polybutadiene carbons, and average values of T1/T2 for each sample are presented in Table 3.

The ¹H NMR procedure used to determine the percent polybutadiene residual double bonds was as follows. An approximately 60 milligram sample of rubber concentrate was weighed to the nearest 0.1 milligram using a Mettler-Toledo AE163 balance. The sample was swelled in 1 milliliter deuterated chloroform (CDCl₃, CAS # 865-49-6, 99.8 atomic % deuterated). The sample was placed on a Spex mixer/mill 8000 high-speed shaker (Spex Industries Inc., Metuchen, N.J.) for 30 minutes at room temperature. The resulting rubber concentrate solution was poured into a 5 millimeter NMR tube without filtering. Proton N-MR spectra were acquired on a Varian Mercury Plus 400 instrument operating at an observed frequency of 400.14 megahertz. Spectra for all samples were collected under quantitative conditions (that is, conditions under which peak areas are proportional to the quantity of protons giving rise to the peak). Spectral parameters included an 8000 hertz spectral width, a 2.7 second acquisition time (21,100 data points), a 4.85 μs pulse width (45° flip angle), and a 5 second pulse delay. Varian's standard pulse sequence, s2pul, was employed. Good signal-to-noise ratio was achieved with 64 acquisitions. Data processing was carried out with 0.5 Hz line broadening and a polynomial baseline correction routine. The integral of the olefinic protons (5.70-4.75 ppm) for the Comparative Example 4 sample (no dicumyl peroxide) was designated 100 percent polybutadiene residual double bonds. The integrals of the other samples were then scaled relative to this 100 percent reference. The values thus indicate the percent of polybutadiene double bonds relative to Comparative Example 4, with lower values indicating a greater degree of crosslinking. Results for each sample are reported in Table 3 as “Percent polybutadiene residual double bonds by ¹H NMR”.

The results for T₁/T₂ show that the uncrosslinked rubber concentrate of Comparative Example 5 exhibited a T₁/T₂ ratio of 527, whereas the crosslinked rubber concentrates of Examples 13-17 exhibited T₁/T₂ ratios of 557, 586, 608, 653, and 728, respectively. Thus, T₁/T₂ ratios greater than about 530 are indicative of crosslinked block copolymer.

The results for percent polybutadiene residual double bonds by ¹H NMR show that for a constant block copolymer amount of 92.5 parts by weight, dicumyl peroxide amounts of 0.05, 0.10, 0.25, 0.50, and 1.00 parts by weight resulted in 99.8, 90.6, 76.1, 59.9, and 37.2 percent residual double bonds, respectively. Lower values of percent residual double bonds are indicative of higher extents of crosslinking.

TABLE 3

| | | |
|---|---|---|
| C. Ex. 5 | Ex. 13 | Ex. 14 |

Compositions

| | | | |
|---|---|---|---|
| SBC | 92.5 | 92.5 | 92.5 |
| xPS | 7.5 | 7.5 | 7.5 |
| DCP | 0 | 0.05 | 0.10 |

Properties

| T₁ value: sp³ Proton (sec) | 0.7765 | 0.7811 | 0.7910 |
|---|---|---|---|
| T₁ value: sp² Proton (sec) | 0.7676 | 0.7754 | 0.7934 |
| T₂ value: sp³ Proton (sec) | 0.001549 | 0.001459 | 0.001408 |
| T₂ value: sp² Proton (sec) | 0.001382 | 0.001335 | 0.001295 |
| Average T₁/T₂ | 527 | 557 | 586 |
| Percent polybutadiene residual | 100.0 | 99.8 | 90.6 |
| double bonds by ¹H NMR | | | |
| | Ex. 15 | Ex. 16 | Ex. 17 |

Compositions

| | | | |
|---|---|---|---|
| SBC | 92.5 | 92.5 | 92.5 |
| xPS | 7.5 | 7.5 | 7.5 |
| DCP | 0.25 | 0.50 | 1.00 |

Properties

| | | | |
|---|---|---|---|
| T₁ value: sp³ Proton (sec) | 0.7882 | 0.7934 | 0.7831 |
| T₁ value: sp² Proton (sec) | 0.8103 | 0.8246 | 0.8764 |
| T₂ value: sp³ Proton (sec) | 0.001367 | 0.001284 | 0.001164 |
| T₂ value: sp² Proton (sec) | 0.001260 | 0.001194 | 0.001117 |
| Average T₁/T₂ | 608 | 653 | 728 |
| Percent polybutadiene residual | 76.1 | 59.9 | 37.2 |
| double bonds by ¹H NMR | | | |

### EXAMPLES 18-22, COMPARATIVE EXAMPLE 6

These examples demonstrate the preparation and characterization of six compositions comprising poly(arylene ether) and rubber concentrate. In Comparative Example 6, the rubber concentrate is not crosslinked and corresponds to Comparative Example 5, above. In Examples 18 to 22, the rubber concentrates are crosslinked with increasing concentrations of dicumyl peroxide and correspond to Examples 13-17, above.

All compositions contained 80 weight percent poly(arylene ether) and 20 weight percent of rubber concentrate. The poly(arylene ether) was a poly(2,6-dimethyl-1,4-phenylene ether) (“PPE”) having an intrinsic viscosity of about 0.46 deciliter per gram in chloroform at 25° C., obtained from GE Plastics. The compositions were prepared by extrusion as described above for Examples 1-9.

Values of T₁, T₂ were determined by ¹H NMR as described above for Examples 10-14. Values of percent polybutadiene residual double bonds were determined by ¹H NMR as described above for Examples 13-17, except that approximately 120 milligrams of sample were dissolved in 2 milliliters deuterated chloroform, and approximately 30 milligrams of 1,4-bis(trichloromethyl)benzene (CAS Reg. No. 68-36-0; Acros Organics, New Jersey) were included as an internal standard that allowed calculation of the equivalent weight percent of uncrosslinked polybutadiene in the sample. Also, after mixing on a high-speed shaker for 30 minutes, the samples were filtered through an Acrodisc 25 millimeter syringe filter with 1 micrometer glass fiber membrane (Part # 4523T; Pall Life Sciences, Ann Arbor, Mich.) into a jar, and 1 milliliter of the filtered solution was pipetted into the NMR tube. Values of “Percent polybutadiene residual double bonds by ¹H NMR” were calculated as described above. Inclusion of the internal standard also allowed calculation of “Equivalent weight percent of uncrosslinked polybutadiene”, which indicates the intensity of the resonances for residual olefinic protons in the rubber. For example, a value of 5.0 weight percent for “Equivalent weight percent of uncrosslinked polybutadiene” means that the composition contains a concentration of olefinic protons equivalent to that of a sample containing 5 weight percent polybutadiene. To calculate the “Equivalent weight percent of uncrosslinked polybutadiene”, the following calculation was employed. First, the integral for the internal standard (8.10 to 7.91 ppm) was set to 100 for each spectrum. Next, the butadiene integral (5.70 to 4.75 ppm) was measured and recorded. The “Equivalent weight percent of uncrosslinked polybutadiene” was then calculated as the product shown below

$$\frac{IntergralBD}{100} * \frac{\frac{54}{2}}{\frac{312.8}{4}} * \frac{InternalStdWeight}{SampleWeight} * 100$$

where the first occurrence of “100” represents the integral of the internal standard, “54” represents the molecular weight of a butadiene repeat unit, “2” is the number of olefinic protons giving rise to the integrated butadiene resonance, “312.8” is the molecular weight of the internal standard, “4′ is the number of protons giving rise to the integrated resonance of the internal standard, “InternalStdWeight” is the weight of the internal standard, “SampleWeight” is the weight of the sample, and the second occurrence of 100 is a conversion factor to express the result in weight percent.

The results for T₁/T₂ show that Comparative Example 6 containing uncrosslinked rubber concentrate exhibited a T₁/T₂ ratio of 423, whereas the Examples 15-19 containing rubber concentrates with increasing levels of crosslinking exhibited T₁/T₂ ratios of 463, 536, 610, 696, and 767, respectively. Thus, T₁/T₂ ratios greater than about 430 are indicative of crosslinked block copolymer.

The results for percent polybutadiene residual double bonds by ¹H NMR show that Examples 18-22, prepared with rubber concentrates having increasing levels of crosslinking, exhibited values of 84.3, 86.0, 66.5, 40.7, and 29.1 relative to 100 percent for Comparative Example 6 prepared with an uncrosslinked rubber concentrate. The results therefore directly demonstrate the presence of crosslinked rubber in the inventive blends.

The results for equivalent weight percent of uncrosslinked polybutadiene show that Comparative Example 6, prepared with an uncrosslinked rubber concentrate, exhibited a value of 5.0, whereas Examples 18-22, prepared with rubber concentrates having increasing levels of crosslinking, exhibited values of 4.3, 4.3, 3.3, 1.9, and 1.3 weight percent. The results also directly demonstrate the presence of crosslinked rubber in the inventive blends. Furthermore, the value of 5.0 weight percent polybutadiene for Comparative Example 6 agrees reasonably well with the theoretical value of 5.2 calculated based on the blend containing 20 weight percent rubber concentrate, the rubber concentrate containing 92.5 weight percent block copolymer, and the block copolymer containing 28 weight percent polybutadiene.

TABLE 4

| | | |
|---|---|---|
| C. Ex. 6 | Ex. 18 | Ex. 19 |

Compositions

| | | | |
|---|---|---|---|
| PPE | 80 | 80 | 80 |
| Comp. Ex. 4 concentrate | 20 | 0 | 0 |
| Ex. 10 concentrate | 0 | 20 | 0 |
| Ex. 11 concentrate | 0 | 0 | 20 |
| Ex. 12 concentrate | 0 | 0 | 0 |
| Ex. 13 concentrate | 0 | 0 | 0 |
| Ex. 14 concentrate | 0 | 0 | 0 |

Properties

| T₁ value: sp³ Proton (sec) | 0.6504 | 0.6787 | 0.7031 |
|---|---|---|---|
| T₁ value: sp² Proton (sec) | 0.6397 | 0.6594 | 0.6860 |
| T₂ value: sp³ Proton (sec) | 0.001570 | 0.001471 | 0.001312 |
| T₂ value: sp² Proton (sec) | 0.001482 | 0.001419 | 0.001277 |
| Average T₁/T₂ | 423 | 463 | 536 |
| Percent polybutadiene residual | 100.0 | 84.3 | 86.0 |
| double bonds by ¹H NMR | | | |
| Equivalent weight percent of | 5.0 | 4.3 | 4.3 |
| uncrosslinked polybutadiene | | | |
| | Ex. 20 | Ex. 21 | Ex. 22 |

Compositions

| | | | |
|---|---|---|---|
| PPE | 80 | 80 | 80 |
| Comp. Ex. 4 concentrate | 0 | 0 | 0 |
| Ex. 10 concentrate | 0 | 0 | 0 |
| Ex. 11 concentrate | 0 | 0 | 0 |
| Ex. 12 concentrate | 20 | 0 | 0 |
| Ex. 13 concentrate | 0 | 20 | 0 |
| Ex. 14 concentrate | 0 | 0 | 20 |

Properties

| | | | |
|---|---|---|---|
| T₁ value: sp³ Proton (sec) | 0.7450 | 0.7813 | 0.8181 |
| T₁ value: sp² Proton (sec) | 0.7230 | 0.7489 | 0.7601 |
| T₂ value: sp³ Proton (sec) | 0.001212 | 0.001087 | 0.001009 |
| T₂ value: sp² Proton (sec) | 0.001196 | 0.001112 | 0.001048 |
| Average T₁/T₂ | 610 | 696 | 767 |
| Percent polybutadiene residual | 66.5 | 40.7 | 29.1 |
| double bonds by ¹H NMR | | | |
| Equivalent weight percent of | 3.3 | 1.9 | 1.3 |
| uncrosslinked polybutadiene | | | |

### EXAMPLES 23-26

These examples describe the preparation of four crosslinked block copolymer concentrates varying in the type of uncrosslinked block copolymer starting material. A tapered styrene-butadiene block copolymer having a styrene content of 72 weight percent, a density at 23° C. of 1.01 gram per cubic centimeter measured according to ASTM D 792-A, and a melt flow index of 7.5 gram per 10 minutes, measured at 200° C. and 5 kilogram load according to ASTM D 1238 G, was obtained as FINACLEAR 520 from Total Petrochemicals (“Tapered SBC” in Table 5). A radial polystyrene-polybutadiene block copolymer having a melt flow rate of 7.5 grams per 10 minutes measured at 200° C. and 5 kilograms load was obtained as K-Resin KR05 from Chevron Phillips Chemical Company (“Radial SBC #1” in Table 5). Proton NMR analysis of this material indicates that it contains 73 weight percent polystyrene, based on the total weight of the block copolymer. A radial block copolymer having a melt flow rate of 9.0 grams per 10 minutes measured at 200° C. and 5 kilograms load was obtained as K-Resin KK38 from Chevron Phillips Chemical Company (“Radial SBC #2” in Table 5). Proton NMR analysis of this material indicates that it contains 68 weight percent polystyrene, based on the total weight of the block copolymer. A radial block copolymer having 74 weight percent polystyrene units and 26 weight percent polybutadiene units, a number average molecular weight of 65,776, and a weight average molecular weight of 159,780 was obtained as K-Resin XK40 from Chevron Phillips Chemical Company (Radial SBC #3” in Table 5). The homopolystyrene (“xPS”) and dicumyl peroxide (“DCP”) were the same as those described above.

Concentrates were prepared as described above for Examples 1-9. Compositions are detailed in Table 5.

TABLE 5

| | Ex. 23 | Ex. 24 | Ex. 25 | Ex. 26 |
|---|---|---|---|---|
| Tapered SBC | 90 | 0 | 0 | 0 |
| Radial SBC #1 | 0 | 90 | 0 | 0 |
| Radial SBC #2 | 0 | 0 | 90 | 0 |
| Radial SBC #3 | 0 | 0 | 0 | 90 |
| xPS | 10 | 10 | 10 | 10 |
| DCP | 0.25 | 0.25 | 0.25 | 0.25 |

### EXAMPLES 27-30, COMPARATIVE EXAMPLES 7-10

These examples describe inventive poly(arylene ether) blends prepared from the crosslinked block copolymer concentrates described in Examples 23-26 and comparative blends prepared from the corresponding uncrosslinked block copolymers. The poly(arylene ether) was the same as that used in previous examples. The blends were prepared as described above for Examples 1-9.

Notched Izod impact strength values and Dyntup total energy values were measured as described above. Percent haze was measured according to ASTM D1003-00 at 23° C. and a thickness of 3.200 millimeters.

Compositions and properties are presented in Table 6. The results show that notched Izod impact strengths were substantially improved for all four inventive blends relative to the corresponding blends with uncrosslinked block copolymers (Example 27 versus Comparative Example 7; Example 28 versus Comparative Example 8; Example 29 versus Comparative Example 9; Example 30 versus Comparative Example 10). The results also show that Dynatup total energy values were substantially improved for three of four inventive blends relative to the corresponding blends with uncrosslinked block copolymers (Example 27 versus Comparative Example 7; Example 28 versus Comparative Example 8; Example 30 versus Comparative Example 10).

TABLE 6

| | | | |
|---|---|---|---|
| C. Ex. 7 | Ex. 27 | C. Ex. 8 | Ex. 28 |

Compositions

| | | | | |
|---|---|---|---|---|
| PPE | 90 | 90 | 90 | 90 |
| Tapered SBC | 10 | 0 | 0 | 0 |
| Ex. 23 concentrate | 0 | 10 | 0 | 0 |
| Radial SBC #1 | 0 | 0 | 10 | 0 |
| Ex. 24 concentrate | 0 | 0 | 0 | 10 |
| Radial SBC #2 | 0 | 0 | 0 | 0 |
| Ex. 25 concentrate | 0 | 0 | 0 | 0 |
| Radial SBC #3 | 0 | 0 | 0 | 0 |
| Ex. 26 concentrate | 0 | 0 | 0 | 0 |

Properties

| | | | | |
|---|---|---|---|---|
| N. Izod (J/m) | 50.9 | 61.2 | 53.2 | 56.7 |
| Total energy (J) | 5.84 | 11.3 | 9.36 | 42.0 |
| Percent haze (%) | 12.0 | 36.1 | 6.2 | 28.2 |

| | | | |
|---|---|---|---|
| | | C. Ex. | |
| C. Ex. 9 | Ex. 29 | 10 | Ex. 30 |

Compositions

| | | | | |
|---|---|---|---|---|
| PPE | 90 | 90 | 90 | 90 |
| Tapered SBC | 0 | 0 | 0 | 0 |
| Ex. 23 concentrate | 0 | 0 | 0 | 0 |
| Radial SBC #1 | 0 | 0 | 0 | 0 |
| Ex. 24 concentrate | 0 | 0 | 0 | 0 |
| Radial SBC #2 | 10 | 0 | 0 | 0 |
| Ex. 25 concentrate | 0 | 10 | 0 | 0 |
| Radial SBC #3 | 0 | 0 | 10 | 0 |
| Ex. 26 concentrate | 0 | 0 | 0 | 10 |

Properties

| | | | | |
|---|---|---|---|---|
| N. Izod (J/m) | 61.7 | 87.1 | 47.2 | 55.4 |
| Total energy (J) | 56.6 | 49.6 | 4.02 | 5.88 |
| Percent haze (%) | 17.0 | 60.1 | 8.7 | 30.8 |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (for example, it includes the degree of error associated with measurement of the particular quantity).

1. A composition, comprising:
a poly(arylene ether); and
a crosslinked block copolymer of an alkenyl aromatic monomer and a conjugated diene; wherein the crosslinked block copolymer comprises 50 to about 90 weight percent of repeating units derived from the alkenyl aromatic monomer.

2. The composition of claim 1, exhibiting after molding at least one of
a reverse notched Izod value of at least 1000 Joules per meter, measured at 23° C. according to ASTM D 256,
a Dynatup Total Energy impact strength of at least 25 Joules, measured at 23° C. according to ASTM D 3763, and
a percent transmittance of at least 60 percent, measured at 23° C. and a thickness of 3.2 millimeters according to ASTM D 1003.

3. The composition of claim 1, exhibiting after molding at least one of
a reverse notched Izod value of about 1000 to about 1850 Joules per meter, measured at 23° C. according to ASTM D 256,
a Dynatup Total Energy impact strength of about 25 to about 45 Joules, measured at 23° C. according to ASTM D 3763, and
a percent transmittance of about 60 to about 85 percent, measured at 23° C. and a thickness of 3.2 millimeters according to ASTM D 1003.

4. The composition of claim 1, exhibiting an extent of crosslinking characterized by average T₁/T₂ value of 463 to 767.

5. The composition of claim 1, wherein the conjugated diene is butadiene, and wherein the composition exhibits an amount of residual polybutadiene aliphatic unsaturation less than or equal to that in 5 weight percent of uncrosslinked polybutadiene.

6. The composition of claim 1, wherein the crosslinked block copolymer comprises at least 70 weight percent of repeating units derived from the alkenyl aromatic monomer.

7. The composition of claim 1, wherein the crosslinked block copolymer is a tapered block copolymer.

8. The composition of claim 1, wherein the crosslinked block copolymer comprises a reaction product of an uncrosslinked block copolymer with dicumyl peroxide.

9. The composition of claim 1, comprising about 80 to about 99 parts by weight of the poly(arylene ether) and about 1 to about 20 parts by weight of the crosslinked block copolymer, wherein all parts by weight are based on 100 parts by weight total of the poly(arylene ether) and the crosslinked block copolymer.

10. The composition of claim 1, further comprising about 0.1 to about 100 parts by weight of a homopolystyrene per 100 parts by weight total of the poly(arylene ether) and the crosslinked block copolymer.

11. The composition of claim 1, further comprising about 0.1 to about 5 parts by weight of a homopolystyrene per 100 parts by weight total of the poly(arylene ether) and the crosslinked block copolymer.

12. The composition of claim 1, further comprising a crosslinked block copolymer of an alkenyl aromatic monomer and a conjugated diene; wherein the crosslinked block copolymer comprises about 10 to less than 50 weight percent of repeating units derived from the alkenyl aromatic monomer.

13. The composition of claim 1, further comprising an uncrosslinked block copolymer of an alkenyl aromatic monomer and a conjugated diene; wherein the uncrosslinked block copolymer comprises 50 to about 90 weight percent of repeating units derived from the alkenyl aromatic monomer.

14. A composition, consisting of:
a poly(arylene ether);
a crosslinked block copolymer of an alkenyl aromatic monomer and a conjugated diene; wherein the crosslinked block copolymer comprises 50 to about 90 weight percent of repeating units derived from the alkenyl aromatic monomer;
optionally, a homopolystyrene;
optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer;
optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer;
optionally, a filler; and
optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

15. A composition, comprising:
a poly(arylene ether) comprising 2,6-dimethyl-1,4-phenylene ether units and having an intrinsic viscosity of about 0.3 to about 0.6 deciliter per gram, measured at 25° C. in chloroform; and
a crosslinked block copolymer of an alkenyl aromatic monomer and a conjugated diene; wherein the crosslinked block copolymer comprises about 60 to about 85 weight percent of repeating units derived from the alkenyl aromatic monomer;
wherein the alkenyl aromatic monomer is styrene;
wherein the conjugated diene is 1,3-butadiene, 2-methyl-1,3-butadiene, or a combination thereof;
wherein the crosslinked block copolymer comprises the reaction product of an uncrosslinked block copolymer and a peroxide compound;
wherein the composition after molding exhibits
a reverse notched Izod value of about 1000 to about 1850 Joules per meter, measured at 23° C. according to ASTM D 256,
a Dynatup Total Energy impact strength of about 25 to about 45 Joules, measured at 23° C. according to ASTM D 3763, and
a percent transmittance of about 60 to about 85 percent, measured at 23° C. and a thickness of 3.2 millimeters according to ASTM D 1003; and
wherein the composition exhibits an extent of crosslinking characterized by an average T₁/T₂ value of 463 to 767.

16. A composition, consisting of:
a poly(arylene ether) comprising 2,6-dimethyl-1,4-phenylene ether units and having an intrinsic viscosity of about 0.3 to about 0.6 deciliter per gram, measured at 25° C. in chloroform; and
a crosslinked block copolymer of an alkenyl aromatic monomer and a conjugated diene; wherein the crosslinked block copolymer comprises about 60 to about 85 weight percent of repeating units derived from the alkenyl aromatic monomer;
wherein the alkenyl aromatic monomer is styrene;
wherein the conjugated diene is 1,3-butadiene, 2-methyl-1,3-butadiene, or a combination thereof;
wherein the crosslinked block copolymer comprises the reaction product of an uncrosslinked block copolymer and a peroxide compound;
optionally, a homopolystyrene;
optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer;
optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer;
optionally, a filler; and
optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof;
wherein the composition after molding exhibits
a reverse notched Izod value of about 1000 to about 1850 Joules per meter, measured at 23° C. according to ASTM D 256,
a Dynatup Total Energy impact strength of about 25 to about 45 Joules measured at 23° C. according to ASTM D 3763, and
a percent transmittance of about 60 to about 85 percent, measured at 23° C. and a thickness of 3.2 millimeters according to ASTM D 1003; and
wherein the composition exhibits an extent of crosslinking characterized by an average T₁/T₂ value of 463 to 767.

17. A composition, comprising:
about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and
about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer;
wherein the alkenyl aromatic monomer is styrene;
wherein the conjugated diene is 1,3-butadiene;
wherein the crosslinked tapered block copolymer comprises the reaction product of an uncrosslinked tapered teleblock copolymer and dicumyl peroxide;
wherein all parts by weight are based on 100 parts by weight total of the poly(arylene ether) and the crosslinked tapered block copolymer;
wherein the composition after molding exhibits
a reverse notched Izod value of about 1000 to about 1850 Joules per meter, measured at 23° C. according to ASTM D 256,
a Dynatup Total Energy impact strength of about 25 to about 45 Joules, measured at 23° C. according to ASTM D 3763, and
a percent transmittance of about 60 to about 85 percent, measured at 23° C. and a thickness of 3.2 millimeters according to ASTM D 1003; and
wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

18. A composition, consisting of:
about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and
about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer;
wherein the alkenyl aromatic monomer is styrene;
wherein the conjugated diene is 1,3-butadiene;
wherein the crosslinked tapered block copolymer comprises the reaction product of an uncrosslinked tapered teleblock copolymer and dicumyl peroxide;
optionally, about 0.1 to about 100 parts by weight of a homopolystyrene per 100 parts by weight total of the poly(arylene ether) and the crosslinked block copolymer;
optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer;
optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer;
optionally, a filler; and
optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof;
wherein all parts by weight are based on 100 parts by weight total of the poly(arylene ether) and the crosslinked tapered block copolymer;
wherein the composition after molding exhibits
a reverse notched Izod value of about 1000 to about 1850 Joules per meter, measured at 23° C. according to ASTM D 256,
a Dynatup Total Energy impact strength of about 25 to about 45 Joules, measured at 23° C. according to ASTM D 3763, and
a percent transmittance of about 60 to about 85 percent, measured at 23° C. and a thickness of 3.2 millimeters according to ASTM D 1003; and
wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

19. A method of forming a thermoplastic composition, comprising:
melt kneading a poly(arylene ether) and a crosslinked block copolymer of an alkenyl aromatic monomer and a conjugated diene; wherein the crosslinked block copolymer comprises 50 to about 90 weight percent of repeating units derived from the alkenyl aromatic monomer.

20. A method of forming a thermoplastic composition, comprising:
melt kneading a crosslinking agent and an uncrosslinked block copolymer of an alkenyl aromatic monomer and a conjugated diene to form a crosslinked block copolymer; wherein the uncrosslinked block copolymer comprises 50 to about 90 weight percent of repeating units derived from the alkenyl aromatic monomer; and
melt kneading a poly(arylene ether) with the crosslinked block copolymer.

21. An article comprising a composition, comprising:
a poly(arylene ether); and
a crosslinked block copolymer of an alkenyl aromatic monomer and a conjugated diene; wherein the crosslinked block copolymer comprises 50 to about 90 weight percent of repeating units derived from the alkenyl aromatic monomer.

22. An article comprising a composition, consisting of:
a poly(arylene ether);
a crosslinked block copolymer of an alkenyl aromatic monomer and a conjugated diene; wherein the crosslinked block copolymer comprises 50 to about 90 weight percent of repeating units derived from the alkenyl aromatic monomer;
optionally, a homopolystyrene;
optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer;
optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer;
optionally, a filler; and
optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

23. An article comprising a composition, comprising:
a poly(arylene ether) comprising 2,6-dimethyl-1,4-phenylene ether units and having an intrinsic viscosity of about 0.3 to about 0.6 deciliter per gram, measured at 25° C. in chloroform; and
a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer;
wherein the alkenyl aromatic monomer is styrene;
wherein the conjugated diene is 1,3-butadiene, 2-methyl-1,3-butadiene, or a combination thereof;
wherein the crosslinked tapered block copolymer comprises the reaction product of an uncrosslinked tapered block copolymer with a peroxide compound;
wherein the composition after molding exhibits
a reverse notched Izod value of about 1000 to about 1850 Joules per meter, measured at 23° C. according to ASTM D 256,
a Dynatup Total Energy impact strength of about 25 to about 45 Joules, measured at 23° C. according to ASTM D 3763, and
a percent transmittance of about 60 to about 85 percent, measured at 23° C. and a thickness of 3.2 millimeters according to ASTM D 1003; and
wherein the composition exhibits an extent of crosslinking characterized by an average T₁/T₂ value of 463 to 767.

24. An article comprising a
composition, consisting of:
a poly(arylene ether) comprising 2,6-dimethyl-1,4-phenylene ether units and having an intrinsic viscosity of about 0.3 to about 0.6 deciliter per gram, measured at 25° C. in chloroform; and
a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer;
wherein the alkenyl aromatic monomer is styrene;
wherein the conjugated diene is 1,3-butadiene, 2-methyl-1,3-butadiene, or a combination thereof;
wherein the crosslinked tapered block copolymer comprises the reaction product of an uncrosslinked tapered block copolymer and a peroxide compound;
optionally, a homopolystyrene;
optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer;
optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer;
optionally, a filler; and
optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof;
wherein the composition after molding exhibits
a reverse notched Izod value of about 1000 to about 1850 Joules per meter, measured at 23° C. according to ASTM D 256,
a Dynatup Total Energy impact strength of about 25 to about 45 Joules, measured at 23° C. according to ASTM D 3763, and
a percent transmittance of about 60 to about 85 percent, measured at 23° C. and a thickness of 3.2 millimeters according to ASTM D 1003; and
wherein the composition exhibits an extent of crosslinking characterized by an average T₁/T₂ value of 463 to 767.

25. An article comprising a composition, comprising:
about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and
about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer;
wherein the alkenyl aromatic monomer is styrene;
wherein the conjugated diene is 1,3-butadiene;
wherein the crosslinked tapered block copolymer comprises the reaction product of an uncrosslinked tapered teleblock copolymer and dicumyl peroxide;
wherein all parts by weight are based on 100 parts by weight total of the poly(arylene ether) and the crosslinked tapered block copolymer;
wherein the composition after molding exhibits
a reverse notched Izod value of about 1000 to about 1850 Joules per meter, measured at 23° C. according to ASTM D 256,
a Dynatup Total Energy impact strength of about 25 to about 45 Joules, measured at 23° C. according to ASTM D 3763, and
a percent transmittance of about 60 to about 85 percent, measured at 23° C. and a thickness of 3.2 millimeters according to ASTM D 1003; and
wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.

26. An article comprising a composition, consisting of:
about 80 to about 95 parts by weight of a poly(arylene ether) comprising 2,6-dimethyl-1,4-phenylene ether units and having an intrinsic viscosity of about 0.3 to about 0.6 deciliter per gram, measured at 25° C. in chloroform; and
about 5 to about 20 parts by weight of a crosslinked tapered block copolymer of an alkenyl aromatic monomer and a conjugated diene; wherein the crosslinked tapered block copolymer comprises about 60 to about 85 weight percent of repeating units derived from the alkenyl aromatic monomer;
wherein the alkenyl aromatic monomer is styrene;
wherein the conjugated diene is 1,3-butadiene;
wherein the crosslinked tapered block copolymer comprises the reaction product of an uncrosslinked tapered teleblock copolymer and dicumyl peroxide;
optionally, about 0.1 to about 100 parts by weight of a homopolystyrene per 100 parts by weight total of the poly(arylene ether) and the crosslinked block copolymer;
optionally, a crosslinked block copolymer of an alkenyl aromatic monomer and a conjugated diene; wherein the crosslinked block copolymer comprises about 10 to less than 50 weight percent of repeating units derived from the alkenyl aromatic monomer;
optionally, an uncrosslinked block copolymer of an alkenyl aromatic monomer and a conjugated diene; wherein the uncrosslinked block copolymer comprises 50 to about 90 weight percent of repeating units derived from the alkenyl aromatic monomer;
optionally, a filler; and
optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof;
wherein all parts by weight are based on 100 parts by weight total of the poly(arylene ether) and the crosslinked tapered block copolymer;
wherein the composition after molding exhibits
a reverse notched Izod value of about 1000 to about 1850 Joules per meter, measured at 23° C. according to ASTM D 256,
a Dynatup Total Energy impact strength of about 25 to about 45 Joules, measured at 23° C. according to ASTM D 3763, and
a percent transmittance of about 60 to about 85 percent, measured at 23° C. and a thickness of 3.2 millimeters according to ASTM D 1003; and
wherein the composition exhibits an extent of crosslinking characterized by an average T₁/T₂ value of 463 to 767, and an amount of residual polybutadiene aliphatic unsaturation less than or equal to that in 5 weight percent of uncrosslinked polybutadiene.
